(19) United States
(12) Patent Application Publication
(10) Pub. No.: US 2018/0261808 A1
(43) Pub. Date: Sep. 13, 2018

(54) BATTERY PACK FOR A MOTORIZED ARCHITECTURAL STRUCTURE COVERING

(71) Applicant: Hunter Douglas, Inc., Pearl River, NY (US)

(72) Inventors: Clark D. Brace, Westminster, CO (US); Charles Culver Gidden Cooper, Arvada, CO (US); Todd Michael Nelson, Louisville, CO (US); Douglas Lorenz, Louisville, CO (US); Ian Bradley Thorne, Thornton, CO (US); Bryan Jeremy Schiffner, Westminster, CO (US); Peter Zagone, Boulder, CO (US); Liliya Gitarts, Thornton, CO (US)

(73) Assignee: Hunter Douglas, Inc., Pearl River, NY (US)

(21) Appl. No.: 15/911,323

(22) Filed: Mar. 5, 2018

Related U.S. Application Data
(60) Provisional application No. 62/469,134, filed on Mar. 9, 2017.
(60) Provisional application No. 62/469,308, filed on Mar. 9, 2017.
(60) Provisional application No. 62/590,804, filed on Nov. 27, 2017.

(51) Int. Cl. H01M 2/10; H01M 2/20; E06B 9/322

(52) U.S. Cl. CPC H01M 2/1055; H01M 2220/10; E06B 9/322; H01M 2/204

(57) ABSTRACT

A battery pack for use with a motorized architectural structure covering is illustrated. The battery pack includes a battery tube, and first and second end caps. The battery tube may include a valley portion located between first and second battery cavities for receiving first and second rows of batteries. The second end cap may include one or more projections (e.g., first and second tabs, handle, etc.) to facilitate removal of the battery pack from mounting clips associated with the motorized architectural structure covering. The removable, second end cap may include first and second release buttons extending into the valley portion. The release buttons may have a wider portion adjacent to the second end cap, and a narrower portion extending at least partially into the valley portion. The release buttons preferably include a tapered, for example, triangular, or trapezoidal shape, to extend into the valley portion for facilitating user engagement therewith.

### CROSS-REFERENCE TO RELATED APPLICATIONS

This application claims priority to pending U.S. Provisional Patent Application Ser. No. 62/469,134, filed Mar. 9, 2017, titled “Battery Pack for a Motorized Architectural Structure Covering”, and claims priority to pending U.S. Provisional Patent Application Ser. No. 62/469,308, filed Mar. 9, 2017, titled “Battery Pack for a Motorized Architectural Structure Covering”, and claims priority to pending U.S. Provisional Patent Application Ser. No. 62/590,804, filed Nov. 27, 2017, titled “Battery Pack for a Motorized Architectural Structure Covering”, the entirety of which applications are incorporated by reference herein.

### FIELD OF THE DISCLOSURE

The present disclosure relates generally to the field of architectural structure coverings, and relates more particularly to a battery pack for use in a motorized architectural structure covering.

### BACKGROUND

Architectural structure coverings may selectively cover a window, a doorway, a skylight, a hallway, a portion of a wall, etc. Generally speaking, horizontal architectural structure coverings may come in a variety of configurations. One type of architectural structure covering may include a motorized controller to lower or raise a covering portion. For example, a motorized drive motor (e.g., an electric motor) can be provided to move the covering portion between an extended position, and a retracted position.

Many known motorized drive motors require power, such as 120 volts, etc., from the facility in which the motorized architectural structure covering is installed to power the motor and control electronics. More recently, battery-powered architectural structure coverings have been introduced. The batteries for these architectural structure coverings can be mounted within, above, or adjacent to the mounting bracket, headrail, fascia, etc. The architectural structure covering may further include brackets for coupling the battery to the architectural structure covering. Unfortunately, these battery-powered systems suffer from many drawbacks, including, for example, requiring the end user to access the battery pack to replace the batteries.

This drawback is compounded by the fact that the battery pack is often coupled to the architectural structure covering behind the headrail associated with the architectural structure covering, and optionally also behind the covering portion, so that the battery pack is concealed. Alternatively, the battery pack may be coupled to the inside surface of the headrail. By concealing the battery pack behind the headrail, and optionally behind the covering portion as well, accessing and removing the battery pack is rendered more difficult, especially since it takes more power to raise the covering portion than lowering the covering portion, which tends to result in the battery pack being more likely to fail when the covering portion is in the extended position, thus requiring the user to reach behind the extended covering portion and the headrail to access the battery pack.

Accordingly, there is need for an improved battery pack wherein the battery pack and the associated batteries located therein are more easily accessible. It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is an improved battery pack for use with a motorized architectural structure covering. The battery pack may include a battery tube having a first end, a second end, and an internal cavity arranged and configured to receive a plurality of batteries therein. The battery pack may also include a first end cap coupled to the first end of the battery tube, and a second end cap coupled to the second end of the battery tube, the second end cap being removably coupled to the second end of the battery tube to enable access to the plurality of batteries contained within the battery pack. The second end cap may also include one or more projections extending from an outer surface thereof for facilitating removal of the battery pack. By incorporating the one or more projections, the user can more easily access, and contact, catch, or latch onto the battery pack, thus pivoting the battery pack downwards for disengaging the battery pack from, for example, one or more mounting clips associated with the motorized architectural structure covering.

In one example embodiment, the battery tube may include first and second cavities interconnected via an intermediate valley portion. The valley portion being narrower than the first and second cavities. The first cavity being configured to receive a first row of batteries while the second cavity may be configured to receive a second row of batteries. The second end cap including first and second release buttons for releasing the second end cap from the second end of the battery tube. The first and second release buttons preferably include a wider portion adjacent the second end cap and a narrower portion at least partially extending into valley portion of the battery tube in-between the first and second cavities. The release buttons preferably are configured to have a larger surface area for contacting by the user without increasing the cross-sectional area or profile of the battery tube, thus contributing to the streamlined profile of the battery pack. By maximizing the surface area, the user is more readily able to contact and press the first and second release buttons, making it easier to remove the second end cap from the battery tube and thus easier to access the batteries located within the battery tube when they need replacement.

The inner sides of the first and second end caps may be configured to create equal length chambers so that the removable second end cap is agnostic with respect to orientation and thus may be inserted into the battery tube in any orientation.

### BRIEF DESCRIPTION OF THE DRAWINGS

FIG. 1 is an exploded front perspective view illustrating a prior art architectural structure covering assembly including a covering shown in an extended position;

FIG. 2 is a front perspective view illustrating an example of a battery pack in accordance with an illustrative embodiment of the present disclosure;

FIG. 3 is an alternate perspective view illustrating the battery pack shown in FIG. 2;

FIG. 4 is a cross-sectional view of an example embodiment of a battery tube used in connection with the battery pack shown in FIG. 2, the cross-section view taken along line Iv-Iv in FIG. 2;

FIG. 5 is a perspective view illustrating an example embodiment of a first end cap used in connection with the battery pack shown in FIG. 2;

FIG. 5A is a perspective view illustrating the first end cap shown in FIG. 5, the first end cap incorporating a shim plate;

FIG. 6 is a front, perspective view illustrating an example embodiment of a second end cap used in connection with the battery pack shown in FIG. 2;

FIG. 7 is an exploded rear, perspective view illustrating the second end cap shown in FIG. 6;

FIG. 8 is a partial, front perspective view of an alternate embodiment of a second end cap used in connection with the battery pack shown in FIG. 2;

FIG. 9 is a perspective view illustrating an alternate, example embodiment of an end cap portion that may be used in connection with the second end cap and battery pack shown in FIG. 2;

FIG. 10 is a perspective view illustrating the end cap portion shown in FIG. 9 coupled to a second end cap; and

FIG. 11 is a perspective view illustrating an alternate example embodiment of an end cap portion coupled to a second end cap.

### DETAILED DESCRIPTION

Embodiments of a battery pack for use in an architectural structure covering in accordance with the present disclosure will now be described more fully hereinafter with reference to the accompanying drawings, in which preferred embodiments of the present disclosure are presented. The battery pack of the present disclosure may, however, be embodied in many different forms and should not be construed as being limited to the embodiments set forth herein. Rather, these embodiments are provided so that this disclosure will convey certain example aspects of the covering to those skilled in the art. In the drawings, like numbers refer to like elements throughout unless otherwise noted.

The improved battery pack is adapted and configured to be used with a motorized architectural structure covering. The battery pack may include a battery tube for receiving one or more batteries therein. The battery pack may also include a first end cap coupled to a first end of the battery tube, and a second end cap coupled to a second end of the battery tube. The second end cap is preferably removably coupled to the second end of the battery tube to enable access to the plurality of batteries contained within the battery pack. The second end cap preferably includes one or more projections extending from an outer surface thereof for facilitating removal of the battery pack. In one example embodiment, the one or more projections may be in the form of first and second tabs to facilitate removal of the battery pack from one or more mounting clips associated with the motorized architectural structure covering. The first and second tabs preferably do not protrude beyond the transverse cross-sectional area of the second end cap, thus contributing to the battery pack having a slim profile. In another embodiment, the one or more projections may be in the form of an extension handle extending from an outer surface of said second end cap. The extension handle including an arcuate curvature so that, in use, the extension handle projects laterally away from and downward from the second end cap.

In one example embodiment, the battery tube preferably includes first and second cavities for receiving first and second rows of batteries, respectively. The first and second cavities being interconnected via an intermediate valley portion. The valley portion is preferably narrower than the first and second cavities. Meanwhile, the second end cap preferably includes first and second release buttons for releasably engaging the battery tube. The first and second release buttons preferably include a wider portion adjacent to the second end cap, and a narrower portion extending at least partially into the valley portion of the battery tube. The first and second release buttons preferably have a shape chosen from one of a triangular shape, or a trapezoidal shape, and may be inwardly tapered from top and bottom surfaces of the second end cap to facilitate easier manipulation for removing the second end cap from the battery tube to access the plurality of batteries located therein.

In addition, the first end cap may include a first spring for contacting and biasing the first row of batteries and a second spring for contacting and biasing the second row of batteries. The second end cap may further include an electrically conductive member arranged and configured to contact the first and second rows of batteries. For example, the second end cap may include first and second springs for contacting and biasing the first and second row of batteries, respectively. The first and second springs of the first end cap and the first and second springs of the second end cap both preferably extend an equal distance from the first and second end caps, respectively, so that the first and second cavities have substantially equal length chambers. In this manner, the second end cap is agnostic with respect to orientation and thus may be inserted into the battery tube in any orientation.

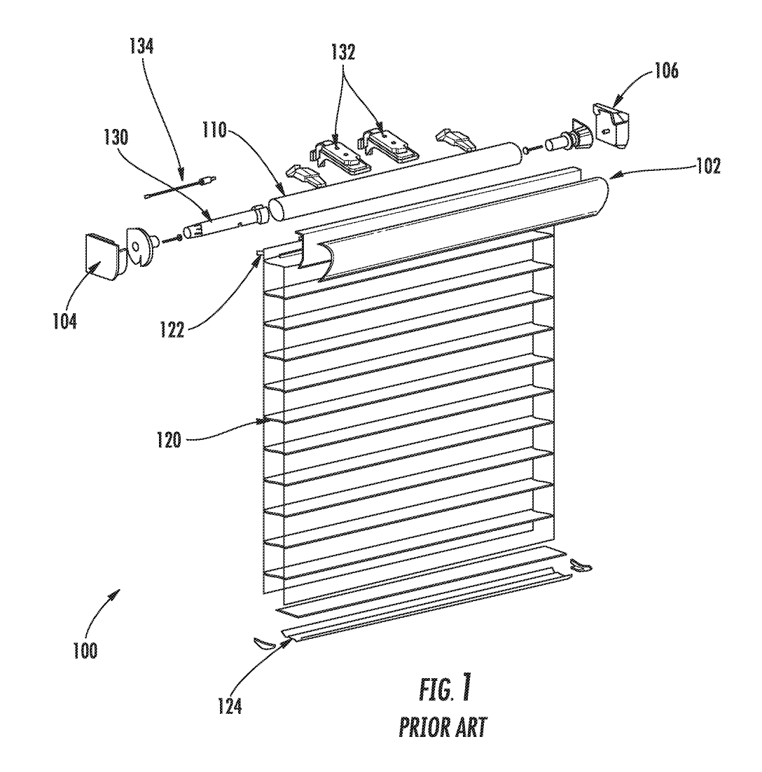

The battery pack of the present disclosure may be used in connection with any motorized architectural structure covering. For example, referring to FIG. 1, an example of a motorized architectural structure covering 100 is illustrated. As shown, the architectural structure covering assembly 100 may include a headrail 102, which in the illustrated embodiment includes opposed end caps 104, 106. The architectural structure covering 100 may also include mounts (not shown) for mounting the architectural structure covering assembly 100 to a wall or other structure. Although a particular example of a headrail 102 is shown in FIG. 1, many different types and styles of headrails exist and could be employed in place of the example headrail of FIG. 1.

The architectural structure covering assembly 100 may also include a rotating member 110 (e.g., a roller tube for a roller shade or a lift rod for a stackable shade), and a covering 120. In the illustrated example, the covering 120 has an upper edge 122 mounted to the rotating member 110 and a lower, free edge 124. As will be readily appreciated by one of ordinary skill in the art, the covering 120 of the architectural structure covering 100 may be configured to be vertically extended and retracted relative to the head rail 102 between an extended position (shown in FIG. 1), wherein the covering 120 may partially or entirely cover a window, a doorway, a skylight, a hallway, a portion of a wall, etc., and a retracted position, wherein the covering 120 may be retracted into, and substantially hidden within, the head rail 102 (e.g., behind a fascia of the head rail).

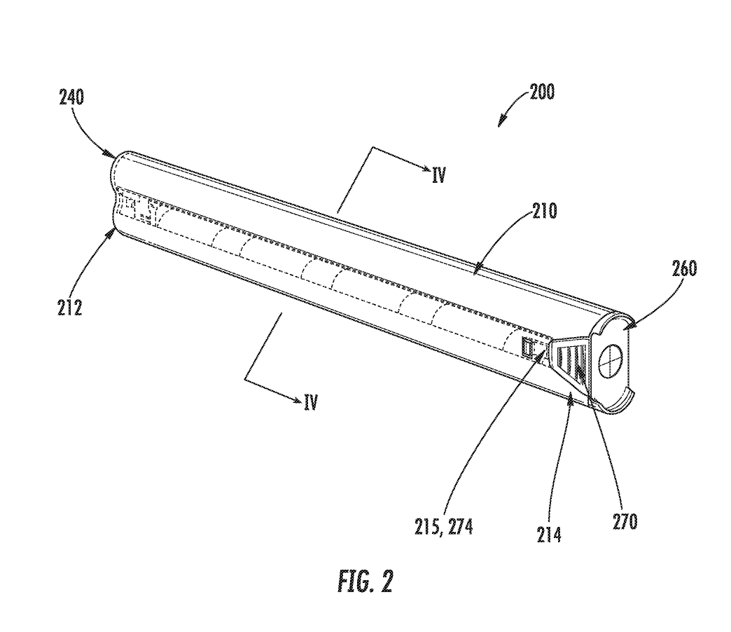

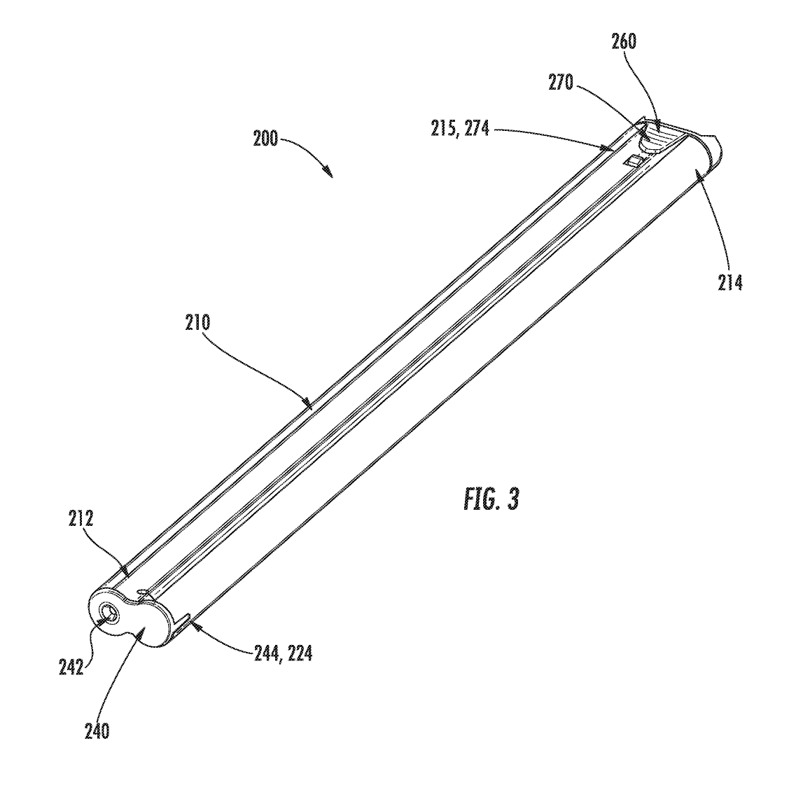

Referring to FIGS. 2 and 3, perspective views of a battery pack 200 according to an example embodiment of the present disclosure will now be described. In use, the battery pack 200 is sized and configured to be electrically connected to the motor 130 (FIG. 1). The battery pack 200 may be located anywhere with respect to the architectural structure covering 100. In one example embodiment, referring to FIG. 1, the architectural structure covering 100 may include brackets 132 for coupling the battery pack 200 to the architectural structure covering 100. As shown, in accordance with an illustrative, non-limiting embodiment of the present disclosure, the battery pack 200 may include a battery tube 210, and first and second end caps 240, 260 located on either end of the battery tube 210. A cable 134 may be provided for coupling and transferring electrical DC energy from the battery pack 200 to the motor 130. For example, the battery pack 200 may include an electrical port 242 for connecting to the cable 134. The port 242 may be located within the first end cap 240, although it is envisioned that the port 242 may be located anywhere on the battery pack 200.

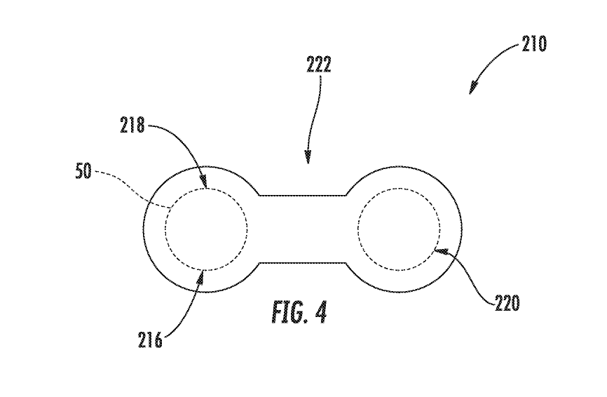

Referring to FIGS. 2-4, the battery tube 210 may have a generally elongated rectangular or tubular shape, although other shapes are contemplated. The battery tube 210 has a first end 212 for receiving the first end cap 240, a second end 214 for receiving the second end cap 260, and an internal cavity 216 (FIG. 4) sized and configured to receive one or more batteries 50 therein. In one example embodiment, the battery tube 210 may include first and second cavities 218, 220 separated by a narrower valley portion 222, although other shapes are contemplated. The first and second cavities 218, 220 may be configured to receive any number and type of batteries 50 required. Preferably, the first and second cavities 218, 220 are configured to receive first and second rows of batteries 50, respectively. For example, the first and second cavities 218, 220 may be configured to receive first and second rows of batteries, respectively, with each row containing six batteries. As will be appreciated by one of ordinary skill in the art, the battery tube 210 may be configured to contain more or fewer batteries, and more or fewer rows of batteries. In addition, the battery tube 210 may be configured to receive any type of battery, for example, AA, AAA, C, or D batteries. In use, the batteries 50 are inserted into the first and second cavities 218, 220 of the battery tube 210.

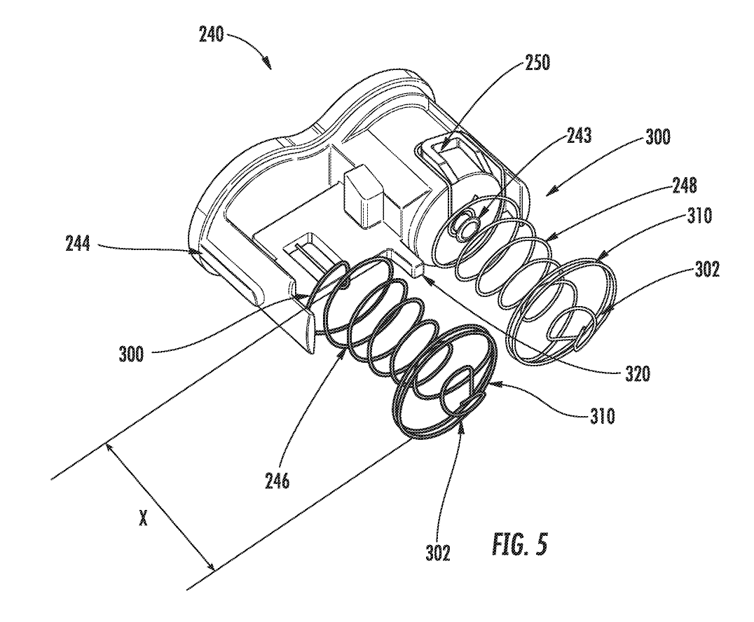

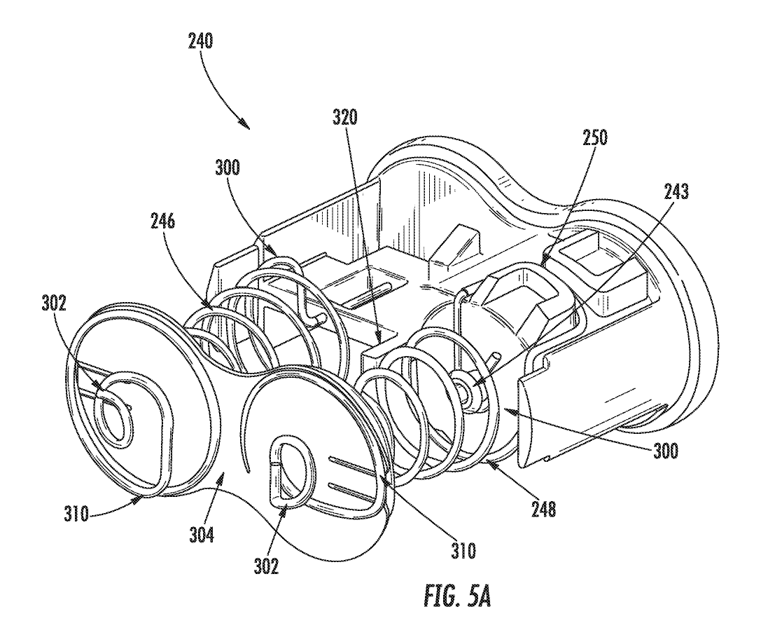

Referring to FIG. 5, a perspective view of an example embodiment of the first end cap 240 according to the present disclosure is illustrated. The first end cap 240 is preferably fixedly securable to the first end 212 of the battery tube 210. That is, once connected to the battery tube 210, the first end cap 240 is arranged and configured so that it is not easily removed from the battery tube 210, although it is envisioned that the first end cap 240 may be removably coupled to the battery tube 210. The first end cap 240 may be arranged and configured so that it can only be inserted into the first end 212 (FIG. 3) of the battery tube 210 in a single orientation. For example, as shown, the first end cap 240 may include a projection 244 for engaging a recess 224 formed near the first end 212 of the battery tube 210. In this manner, the first end cap 240 can only be inserted into the first end 212 of the battery tube 210 when the projection 244 is properly aligned with the recess 224 formed in the battery tube 210. It should be understood that any other mechanism for ensuring proper alignment of the first end cap 240 relative to the first end of the battery tube 210 may be used.

The first and second cavities 218, 220 are preferably configured to create substantially equal length chambers. This may be accomplished by any mechanism. As shown in FIG. 5, the first end cap 240 may include a first spring 246 for contacting and biasing the batteries 50 located in the first cavity 218 toward the second end cap 260. Generally speaking, in known prior art devices, the batteries 50 located in the second cavity 220 would directly contact an electrical terminal 243 extending through the electrical port 242. However, according to one aspect of the present disclosure, the first end cap 240 may include a second spring 248 positioned and configured to contact and bias the batteries 50 located in the second cavity 220. The second spring 248 electrically engages the electrical terminal 243 so that electrical DC energy can be transferred from the batteries 50 through the second spring 248 to the electrical terminal 243 to the cable 134 (FIG. 1) and to the electrical motor 130. That is, the second spring 248 is in electrical continuity with the electrical terminal 243 for transferring power thereto. As shown, the first and second springs 246, 248 are arranged and configured so that they preferably extend an equal distance X from the first end cap 240. In addition, the first and second springs 246, 248 are arranged and configured so that they preferably apply an equal amount of biasing force to the batteries. That is, the first spring 246 preferably has a first length, the second spring 248 preferably has a second length, the first and second lengths being arranged and configured so that the first and second springs 246, 248 extend an equal distance X from the first end cap 240, and thus extend an equal distance into the first and second cavities 218, 220. In this manner, by extending the first and second springs 246, 248 into the first and second cavities 218, 220 an equal distance X from the first end cap 240 helps facilitate the creation of equally length chambers.

As shown in FIG. 5, in one embodiment, the first and second springs 246, 248 may each be in the form of a coil spring, although other forms are envisioned. The first and second springs 246, 248 may each include a first end 300 adjacent to the first end cap 240 and a second end 302 configurable for contacting the batteries 50 when inserted into the first and second cavities 218, 220, respectively, of the battery pack 200. The first and second springs 246, 248 preferably include a stabilizing mechanism for maintaining the stability of the first and second springs 246, 248 as they are being axially compressed by the batteries 50 being inserted into the first and second cavities 218, 220, respectively. The stabilizing mechanism preferably operates to ensure that the first and second springs 246, 248 do not contact each other, which would result in an electrical short. As shown, the stabilizing mechanism may be in the form of an enlarged diameter coil 310 formed in each of the first and second coiled springs 246, 248 adjacent the second ends 302 thereof. In one embodiment, the enlarged diameter coil 310 preferably has an outer diameter substantially similar to the outer diameter of the batteries 50 being inserted into the battery pack 200. In this manner, the larger diameter coil 310 ensures that the first and second springs 246, 248 are axially compressed via the batteries 50 and that the first and second springs 246, 248 do not bend and extend laterally into the cavity area between the first and second rows of batteries 50. In addition, the first end cap 240 may include a stabilizing and insulating feature 320 that prevents the first and second coiled springs 246, 248 from contacting each other when compressed. As shown, the stabilizing and insulating feature 320 may be in the form of a projection extending from the inner surface of the first end cap 240 into at least a portion of the space between the first and second springs 246, 248.

Moreover, referring to FIG. 5A, the stabilizing mechanism may incorporate an insulating plate 304 for coupling to the first and second springs 246, 248 to ensure that the first and second springs 246, 248 do not contact one another during axially compression of the first and second springs 246, 248 via the batteries 50. As illustrated, the insulating plate 304 may be coupled to the first and second springs 246, 248 via the larger diameter coils 310 formed in each of the first and second coiled springs 246, 248 adjacent to the second ends 302 thereof, although it is envisioned that the insulating plate 304 may be coupled to the first and second springs 246, 248 by any other mechanism. In use, the insulating plate 304 may be manufactured from any suitable insulating material and formed by any mechanism. In one example embodiment, the insulating plate 304 may be in the form of a flat plate member made from die cut insulation material.

The first and second springs 246, 248 may be coupled to the first end cap 240 by any means now known or hereafter developed. As shown, in one example embodiment, the first spring 246 may be molded into the first end cap 240 while the second spring 248 may be removably coupled to the first end cap 240 such as, for example, by extending around a projection or hook 250 formed on the first end cap 240. It will be appreciated that these are examples of connection arrangements, and that others can be used.

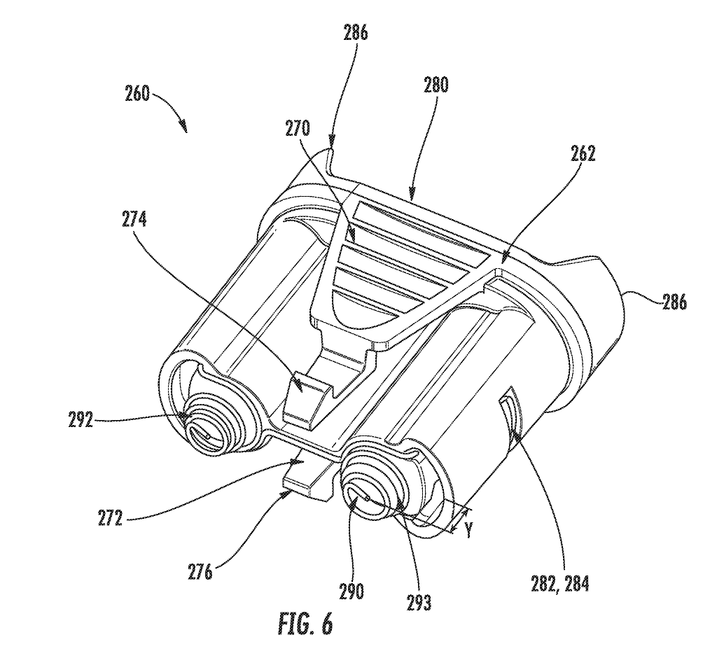

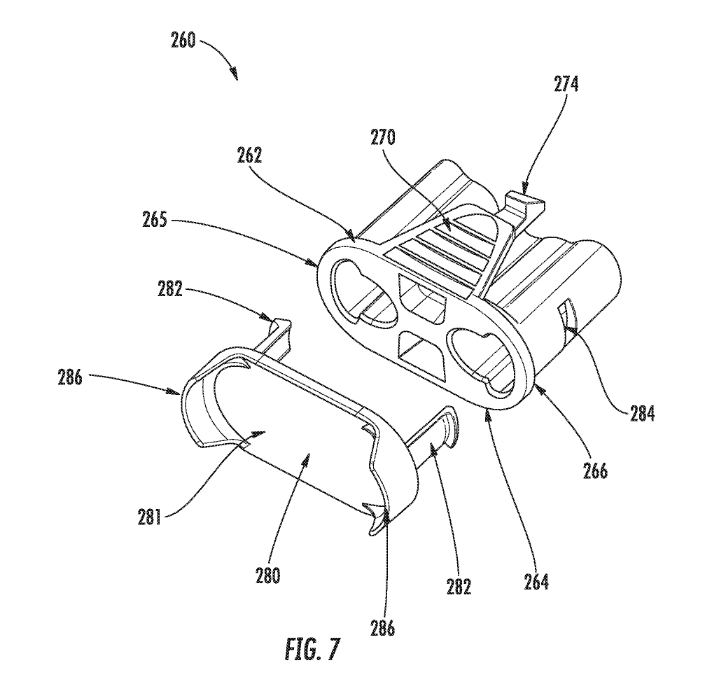

Referring to FIGS. 6 and 7, perspective views of an example embodiment of the second end cap 260 according to the present disclosure is illustrated. The second end cap 260 is preferably removably couplable to the second end 214 (FIG. 2) of the battery tube 210. That is, once connected to the battery tube 210, the second end cap 260 is arranged and configured so that it can be relatively easily removed from the battery tube 210 so that the user can access the batteries 50 as needed, for example, to replace the batteries when required. The second end cap 260 can then be recoupled to the battery tube 210 once the batteries 50 have been replaced. The second end cap 260 is preferably arranged and configured so that it can be inserted into the second end 214 of the battery tube 210 in one of two orientations. That is, as will be described in greater detail below, the second end cap 260 is preferably arranged and configured so that it can be inserted into the second end 214 of the battery tube 210 either right-side up or upside down.

The second end cap 260 may be removably couplable to the second end 214 of the battery tube 210 by any mechanism now known or hereafter developed. As shown, the second end cap 260 may include first and second release buttons 270, 272. The first and second release buttons 270, 272 may include first and second engaging members 274, 276, respectively, for engaging correspondingly shaped recesses 215 formed in the battery tube 210 adjacent the second end 214 thereof. For example, the first and second engaging members 274, 276 may be in the form of first and second hooks for engaging recesses 215 formed in the battery tube 210.

The first and second release buttons 270, 272 may extend from top and bottom surfaces 262, 264 of the second end cap 260. Preferably, the first and second release buttons 270, 272 are arranged and configured so that when the second end cap 260 is coupled to the second end 214 of the battery tube 210, a portion of each of the first and second release buttons 270, 272 is extendible into the valley portion 222 of the battery tube 210, in-between the first and second cavities 218, 220, when the user presses the first and second release buttons 270, 272 toward each other. The first and second release buttons 270, 272 preferably have a shape chosen from one of a triangular shape, or trapezoidal shape. Alternatively, the first and second release buttons 270, 272 can have any other shape including, but not limited, to a square shape, or a rectangular shape. More preferably, the first and second release buttons 270, 272 are inwardly tapered from the top and bottom surfaces 262, 264 of the second end cap 260 toward the first and second engaging members 274, 276. In this manner, the first and second release buttons 270, 272 provide the user with a more ergometric push-button with a larger surface area for contacting the first and second release buttons 270, 272. That is, as shown, the first and second release buttons 270, 272 preferably have a wider portion adjacent to the second end cap 260, and a narrower portion toward the first and second engaging members 274, 276, so that at least a portion of the first and second release buttons 270, 272 can extend at least partially into the valley portion 222 of the battery tube 210 when the release buttons 270, 272 are pressed. In this manner, the release buttons 270, 272 have a larger surface area for contacting by the user without increasing the cross-sectional area or profile of the battery tube 210, thus contributing to the streamlined profile of the battery pack 200. By maximizing this surface area, the user is more readily able to contact and press the first and second release buttons 270, 272, making it easier to remove the second end cap 260 from the battery tube 210 and thus easier to access the batteries 50 located within the battery tube 210 when they need replacement. As will be readily appreciated by one of ordinary skill in the art, pressing the first and second release buttons 270, 272 toward each other causes the first and second engaging members (e.g., hooks) 274, 276 to move inwards away from the outer surface of the battery tube 210 and thus out of engagement with the recesses 215 formed in the battery tube 210, thereby releasing the second end cap 260 from the battery tube 210.

Referring to FIG. 7, the second end cap 260 may also include an end cap portion 280. The end cap portion 280 may be coupled to the second end cap 260 by any means now known or hereafter developed including, for example, integrally formed, an adhesive, fasteners, etc. As shown, the end cap portion 280 may include first and second legs and projections 282 for engaging recesses 284 formed in the second end cap 260. In one example embodiment, the first and second legs and projections 282 may extend in a longitudinal direction (e.g., parallel to the longitudinal direction of the battery pack 200). The end cap portion 280 preferably also includes first and second tabs 286 extending from an outer surface 281 of the end cap portion 280. In one example embodiment, the first and second tabs 286 may extend in a longitudinal direction (e.g., parallel to the longitudinal direction of the battery pack 200). In the illustrated embodiment, the first and second legs and projections 282 extend in a direction opposite that of the first and second tabs 286. In this manner, the first and second tabs 286 preferably do not protrude beyond the transverse cross-sectional area of the second end cap 260, thus providing the battery pack 200 with a slim profile. The first and second tabs 286 may have any shape. As shown, in one example embodiment, the first and second tabs 286 each have a semi-circular cross-sectional shape substantially corresponding to the semi-circular cross-sectional shape of the second end cap 260 and the semi-circular cross-sectional shape of the first and second cavities 218, 220 of the battery tube 210. That is, the second end cap 260 may include first and second curved side edges 265, 266. The first and second tabs 286 preferably include a semi-circular cross-sectional shape that substantially corresponds to the first and second curved side edges 265, 266 of the second end cap 260.

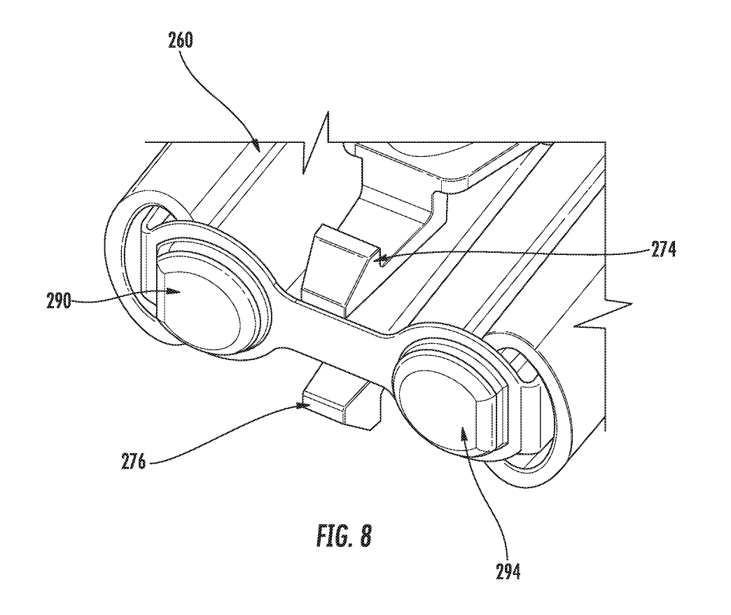

In use, the first and second tabs 286 facilitate removal of the battery pack 200, for example, from the mounting clips 132. That is, as previously described and referring to FIG. 1, the battery pack 200 may be coupled to the architectural structure covering 100 behind the headrail 102, and optionally behind the covering 120, so that the battery pack 200 is concealed. By concealing the battery pack 200 behind the headrail 102, and optionally behind the covering 120 as well, accessing and removing the battery pack 200 is rendered more difficult, especially since it takes more power to raise the covering 120 than lowering the covering 120, which tends to result in the batteries 50 being more likely to be depleted when the covering 120 is in the extended position, and thus requiring the user to reach behind the extended covering 120 and the headrail 102 to access the battery pack 200. The first and second tabs 286 enable the user to more easily access and contact, catch, or latch onto the battery pack 200, to pivot the battery pack 200 downwards and disengage the battery pack 200 from the clips 132. The second end cap 260 may also include an electrically conductive member 290 so that the batteries 50 (FIG. 4) in the first cavity 218 are serially connected to the batteries 50 located in the second cavity 220. As shown, the electrically conductive member 290 may include first and second springs 292, 293 for contacting and biasing the batteries 50 located in the first and second cavities 218, 220, respectively, toward the first end cap 240. In use, as previously described in connection with the first end cap 240, the first spring 292 preferably has a first length, the second spring 293 preferably has a second length, the first and second lengths being arranged and configured so that the first and second springs 292, 293 extend an equal distance Y from the second end cap 260, and thus extend an equal distance into the first and second cavities 218, 220. Alternatively, referring to FIG. 8, the electrically conductive member 290 may be in the form of a plate 294. The electrically conductive member 290 may be coupled to the second end cap 260 by any means now known or hereafter developed. By utilizing an electrically conductive member 290 to couple the batteries 50 in the first cavity 218 with the batteries 50 in the second cavity 220, the batteries 50 become serially electrically connected with one another. In addition, the second end cap 260 becomes agnostically arranged with respect to the batteries 50 and the battery tube 210. That is, the electrically conductive member 290 is preferably arranged and configured so that it extends an equal distance Y from the second end cap 260 into the first and second cavities 218, 220. For example, the first and second springs 292, 293 extend an equal distance Y from the second end cap 260 (e.g., extend an equal distance Y into the first and second cavities 218, 220, respectively). In this manner, the second end cap 260 can be inserted in either of two orientations (e.g., with the first spring 292 located in the first cavity 218, or with the first spring 292 in the second cavity 220) and yet still maintain a proper electrical connection. In this manner, by extending the first and second springs 292, 293 an equal distance Y from the second end cap 260 into the first and second cavities 218, 220, respectively and by extending the first and second springs 246, 248 into the first and second cavities 218, 220 an equal distance X from the first end cap 240, substantially equally length chambers may be created.

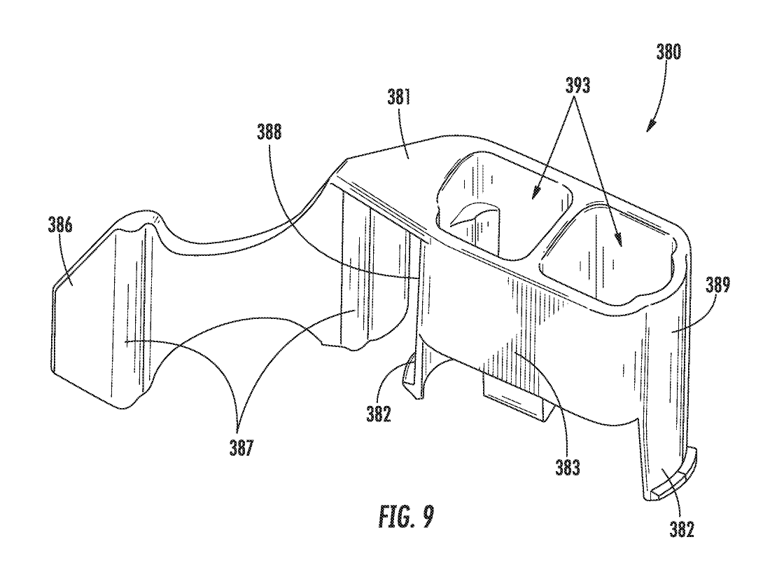

As previously mentioned in connection with FIG. 7, the second end cap 260 may also include an end cap portion 280. The end cap portion 280 may be coupled to the second end cap 260 by any means now known or hereafter developed including, for example, integrally formed, an adhesive, fasteners, etc. Referring now to FIGS. 9-11, in one embodiment, an alternative embodiment of an end cap portion 380 may include a body portion 383 for coupling to the second end cap 360. For example, as illustrated, a portion of the body portion 383 may be sized and configured to be received within an opening 362 formed in the second end cap 360. In addition, the body portion 383 of the end cap portion 380 may include first and second legs and projections 382 for engaging recesses 364 formed in the second end cap 260. In the illustrated embodiment, the first and second legs and projections 382 extend in a longitudinal direction (e.g., parallel to the longitudinal direction of the battery pack 200).

The end cap portion 380 preferably also includes an extension handle 386 extending from a side surface of an outer, end surface 381 of the end cap portion 380. Alternatively, the extension handle 386 may extend from a portion of the body portion 383 not received within the opening 362 formed in the second end cap 360. In one example embodiment, the extension handle 386 may have an arcuate shape extending laterally outward and away from the body of the end cap portion 380 so that, in use (e.g., when coupled to the battery pack 200 via the second end cap 360), the extension handle 386 projects laterally away from, and downward from, the second end cap 360. In this manner, the extension handle 386 preferably protrudes beyond the transverse cross-sectional area of the second end cap 360, thus facilitating easier access to a user attempting to locate and remove the battery pack 200. As illustrated, in one example embodiment, the extension handle 386 may have an hourglass shape to facilitate grasping by the user. However, it should be understood that the extension handle 386 may have any other shape. In addition, and/or alternatively, the extension handle 386 may include one or more ribs 387 formed on an inner surface of the handle 386. In use, the ribs 387 also facilitate grasping by the user. It should be noted that while the extension handle 386 is illustrated with two ribs 387, the extension handle may include more or less ribs, and that the ribs 387 may be omitted in their entirety. In use, the one or more ribs 387 increase the rigidity of the extension handle 386.

Moreover, as illustrated, the end cap portion 380 may incorporate one or more openings 393 formed therein. It should be noted that while the end cap portion 380 is illustrated with two separate and distinct openings 393, the end cap portion 380 may include more or less openings, and that the openings may be omitted in their entirety.

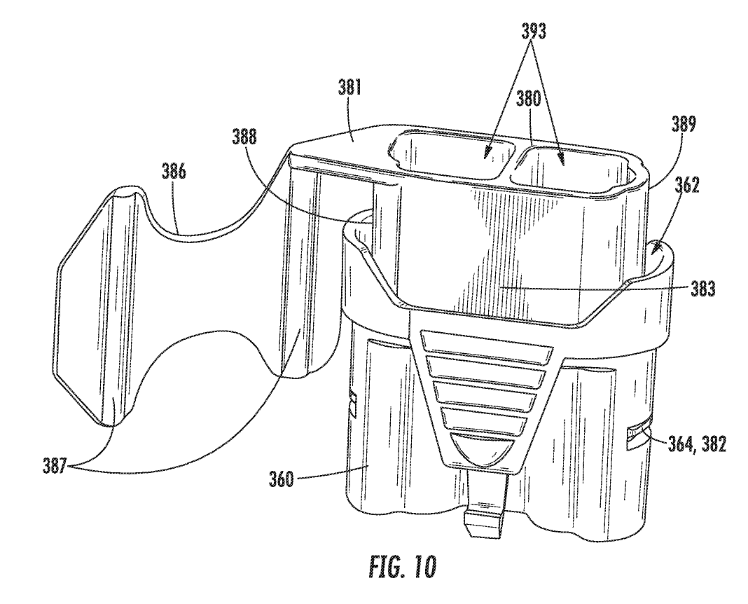

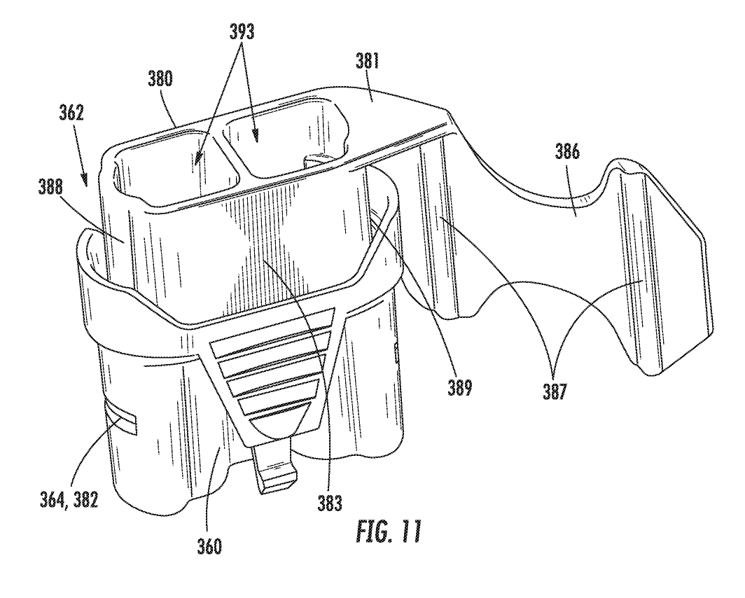

Referring to FIGS. 9 and 10, in use, the extension handle 386 may laterally extend from a left-hand side 388 of the end cap portion 380. Alternatively, referring to FIG. 11, in use, the extension handle 386 may laterally extend from a right-hand side 389 of the end cap portion 380. It will also be understood that the extension handle 386 could, alternatively extend from any surface of the end cap portion 380 in order to provide a desired grippable surface in use. The particular end cap portion 380 used may depend on the orientation of the architectural-structure covering 100.

It should be noted, that while the second end cap portion 380 has been described and illustrated as including a single extension handle 386, it is envisioned that the second cap portion 380 may include two or more extension handles. In addition, or alternatively, while the extension handle 386 has been described as having an hourglass or arcuate shape so that the extension handle 386 projects laterally away from, and downward from, the second end cap 360, it is envisioned that the extension handle 386 may have any desired shape that will facilitate a user grasping the handle 386. In addition, or alternatively, while the extension handle 386 has been described and illustrated as being integrally formed with the end cap portion 380, the extension handle 386 may be separately formed and coupled to the end cap portion 380 by any means now known or hereafter developed including, for example, an adhesive, fasteners, etc. In addition, or alternatively, while the end cap portion 380 has been described and illustrated as being separately formed with respect to the second end cap 360, the end cap portion 380 may be integrally formed with the second end cap 360.

In use, the extension handle 386 facilitates removal of the battery pack 200, for example, from the mounting clips 132, by allowing a user to grasp the extension handle 386 and pivot the battery pack 200 out of engagement with the mounting clips 132. That is, as previously described and referring to FIG. 1, the battery pack 200 may be coupled to the architectural structure covering 100 behind the headrail 102, and optionally behind the covering 120, so that the battery pack 200 is concealed. By concealing the battery pack 200 behind the headrail 102, and optionally behind the covering 120 as well, accessing and removing the battery pack 200 is rendered more difficult, especially since it takes more power to raise the covering 120 than lowering the covering 120, which tends to result in the batteries 50 being more likely to deplete when the covering 120 is in the extended position, thus requiring the user to reach behind the extended covering 120 and the headrail 102 to access the battery pack 200. By incorporating the extension handle 386, the user can more easily access and contact, catch, or latch onto the battery pack 200, to pivot the battery pack 200 downwards to disengage the battery pack 200 from the clips 132.

By utilizing a battery pack 200 according to the present disclosure, the battery pack 200 is more readily removed from the architectural structure covering assembly for replacement. In addition, the second or removable end cap 260 is easier to remove than prior end caps, and the second or removable end cap 260 can be coupled to the battery tube 210 in either orientation due to the design of the electrically conductive members.

It should be noted that while certain embodiments described herein refer to certain orientations and directions, it should be understood that any orientation or direction of implementation could be used and still fall within the described embodiments. Furthermore, it should also be understood that the directions (e.g. top, bottom, left, right, front, back, up and down) described herein are used for ease of description, and refer only to directions associated with the views illustrated in the corresponding figures.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A battery pack for use with a motorized architectural structure covering, said battery pack comprising:
a battery tube having a first end, a second end, and at least one cavity arranged and configured to receive a plurality of batteries therein;
a first end cap coupleable to said first end of said battery tube; and
a second end cap coupleable to said second end of said battery tube, said second end cap being removably coupleable to said second end of said battery tube;
wherein said second end cap includes one or more projections extending from an outer surface thereof for facilitating removal of the battery pack.

2. The battery pack of claim 1, wherein said one or more projections are first and second tabs, said first and second tabs extending in a longitudinal direction with respect to said outer surface of said second end cap; said first and second tabs facilitating removal of said battery pack from one or more mounting clips associated with the motorized architectural structure covering.

3. The battery pack of claim 1, wherein said at least one cavity includes first and second cavities interconnected via an intermediate valley portion, said valley portion being narrower than said first and second cavities; said first cavity is arranged and configured to receive a first row of batteries, and the second cavity is arranged and configured to receive a second row of batteries.

4. The battery pack of claim 3, wherein said second end cap includes first and second release buttons having first and second engaging members, respectively, for releasably engaging first and second recesses formed in said battery tube adjacent said second end thereof.

5. The battery pack of claim 4, wherein said first and second release buttons extend from top and bottom surfaces, respectively, of said second end cap, said first and second release buttons each including a portion that is extendable into said valley portion of said battery tube in-between said first and second cavities when said second end cap is coupled to said battery tube.

6. The battery pack of claim 5, wherein said first and second release buttons have a wider portion adjacent the second end cap and a narrower portion extendable into said valley portion of said battery tube; said first and second release buttons being inwardly tapered from said top and bottom surfaces of said second end cap.

7. The battery pack of claim 1, wherein said one or more projections are first and second tabs, said first and second tabs having a semi-circular cross-sectional shape substantially corresponding to a portion of said second end cap.

8. (canceled)

9. (canceled)

10. The battery pack of claim 1, wherein:
said second end cap further includes first and second springs arranged and configured to contact first and second rows of batteries, respectively; said first and second springs being in electrical contact with each other; and
the first spring member has a first length and the second spring member has a second length, the first and second lengths being arranged and configured so that the first and second spring members extend an equal distance from the second end cap.

11. The battery pack of claim 1, wherein said second end cap further includes an electrically conductive plate member arranged and configured to contact first and second rows of batteries.

12. The battery pack of claim 1, wherein said second end cap further includes an electrically conductive member arranged and configured so that said second end cap is insertable into said second end of said battery tube in any orientation.

13. (canceled)

14. The battery pack of claim 1, wherein:
said first end cap includes a first spring for contacting and biasing a first row of batteries and a second spring for contacting and biasing a second row of batteries; said first and second springs extend an equal distance away from said first end cap; and
said first and second springs are each a coiled spring having a first end adjacent to said first end cap and a second end arranged and configured to contact first and second batteries, respectively, said first and second coiled springs each including a larger diameter coil formed in said first and second coiled springs adjacent said second ends thereof for contacting the first and second batteries, respectively.

15. (canceled)

16. The battery pack of claim 14, wherein said first end cap further includes a stabilizing and insulating feature for preventing said first and second coiled springs from contacting each other when compressed.

17. The battery pack of claim 16, wherein said stabilizing and insulating feature is a projection extending from an inner surface of said first end cap into at least a portion of a space positioned between said first and second coiled springs.

18. The battery pack of claim 14, further comprising an insulating plate for coupling to an end of said first and second coiled springs to prevent said first and second coiled springs from contacting each other.

19. The battery pack of claim 1, wherein said one or more projections include an extension handle extending from an outer surface of said second end cap.

20. The battery pack of claim 19, wherein said extension handle includes an arcuate curvature so that, in use, said extension handle projects laterally away from and downward from the second end cap.

21. A battery pack for use with a motorized architectural structure covering comprising:
a battery tube having a first end, a second end, and first and second cavities interconnected via an intermediate valley portion, the first and second cavities arranged and configured to receive first and second rows of batteries, respectively, therein;
a first cap coupleable to said first end of said battery tube; and
a second end cap coupleable to said second end of said battery tube, said second end cap being removably coupleable to said second end of said battery tube;
wherein:
said second end cap includes first and second release buttons for engaging said battery tube adjacent said second end thereof, said first and second release buttons extending from top and bottom surfaces of said second end cap, at least a portion of said first and second release buttons extending into said valley portion of said battery tube in-between said first and second cavities, said first and second release buttons having a wider portion adjacent the second end cap, and a narrower portion extending at least partially into said valley portion, the first and second release buttons being inwardly tapered from the top and bottom surfaces, respectively.

22. A battery pack for use with a motorized architectural structure covering, said battery pack comprising:
a battery tube having a first end, a second end, a first cavity arranged and configured to receive a first row of batteries therein, and a second cavity arranged and configured to receive a second row of batteries therein;
a first end cap coupleable to said first end of said battery tube; and
a second end cap coupleable to said second end of said battery tube, said second end cap being removably coupleable to said second end of said battery tube;
wherein said first end cap includes a first spring for contacting and biasing the first row of batteries and a second spring for contacting and biasing the second row of batteries; said first and second springs extending a substantially equal distance away from said first end cap; and
wherein said second end cap includes an electrically conductive member arranged and configured to contact the first and second rows of batteries, said electrically conductive member extending a substantially equal distance away from said second end cap.

23. The battery pack of claim 21, wherein said valley portion is narrower than said first and second cavities so that said battery tube has an approximate figure eight cross-sectional shape.

24. The battery pack of claim 21, wherein said first and second release buttons include first and second hooks, respectively, for engaging first and second recesses formed in the battery tube.

25. The battery pack of claim 24, wherein said first and second release buttons have a shape chosen from one of a triangular shape or a trapezoidal shape.

26. The battery pack of claim 22, wherein said second end cap includes one or more projections extending from an outer surface thereof for facilitating removal of the battery pack.

27. The battery pack of claim 22, wherein:
said first and second cavities are interconnected via an intermediate valley portion, said valley portion being narrower than said first and second cavities so that said battery tube has an approximate figure eight cross-sectional shape; and
said second end cap includes first and second release buttons for engaging said battery tube adjacent said second end thereof, said first and second release buttons extending from top and bottom surfaces of said second end cap, at least a portion of said first and second release buttons extending into said valley portion of said battery tube in-between said first and second cavities, said first and second release buttons having a wider portion adjacent the second end cap, and a narrower portion extending at least partially into said valley portion, the first and second release buttons being inwardly tapered from the top and bottom surfaces, respectively.
